(19) United States
(12) Patent Application Publication
(10) Pub. No.: US 2020/0225838 A1
(43) Pub. Date: Jul. 16, 2020

(54) COMPUTER PROGRAM PRODUCT AND INFORMATION PROCESSING METHOD

(71) Applicants: Kabushiki Kaisha Toshiba, Minato-ku (JP); Toshiba Memory Corporation, Minato-ku (JP)

(72) Inventors: Xinxiao Li, Yokohama (JP); Junpei Kida, Fuchu (JP)

(73) Assignees: Kabushiki Kaisha Toshiba, Minato-ku (JP); Toshiba Memory Corporation, Minato-ku (JP)

(21) Appl. No.: 16/560,122

(22) Filed: Sep. 4, 2019

(30) Foreign Application Priority Data
Jan. 11, 2019 (JP) 2019-003857

(51) Int. Cl. G06F 3/0484; G06F 3/0482; G06F 16/26

(52) U.S. Cl. CPC G06F 3/04847; G06F 2203/04803; G06F 16/26; G06F 3/0482

(57) ABSTRACT

According to an embodiment, a computer program product has a computer readable medium including programmed instructions. The instructions, when executed by a computer, cause the computer to function as a first rendering unit, an input control unit, a first processing unit, a second processing unit, and a second rendering unit. The first rendering unit is configured to render a first chart from first visualization object data. The input control unit is configured to receive an operation input to the first chart. The first processing unit is configured to update the first visualization object data based on the operation input. The second processing unit is configured to, when second visualization object data is updated in a manner linked to processing performed by the first processing unit, update the second visualization object data. The second rendering unit is configured to render a second chart from the second visualization object data.

### CROSS-REFERENCE TO RELATED APPLICATIONS

This application is based upon and claims the benefit of priority from Japanese Patent Application No. 2019-003857, filed on Jan. 11, 2019; the entire contents of which are incorporated herein by reference.

### FIELD

Embodiments described herein relate generally to a computer program product and an information processing method.

### BACKGROUND

Conventionally, a visualization system has been known that stores a plurality of pieces of visualization object data in a local recording medium and visualizes the pieces of visualization object data on the basis of charts rendered from the pieces of visualization object data. For example, a technique is known that uses a common key such as time to establish operation linkages among a plurality of charts generated from a plurality of pieces of data. Furthermore, for example, a technique is known that uses one multidimensional data set, finds a common dimension from this data set, extracts partial data to be visualized, and establishes operation linkages among charts.

However, there is a problem in that such operation linkages among a plurality of charts cannot be established when a specific common key or common dimension cannot be obtained among a plurality of data sets corresponding to the charts.

### BRIEF DESCRIPTION OF THE DRAWINGS

FIG. 1 is a diagram illustrating an example of a functional configuration of an information processing system according to a first embodiment;

FIG. 2 is a diagram illustrating an example of a visualization method according to the first embodiment;

FIG. 3 is a diagram illustrating an example of a data transmitting/receiving method according to the first embodiment;

FIG. 4 is diagram illustrating an example of a data transmitting/receiving method according to a second embodiment;

FIG. 5 is a diagram illustrating an example of operation linkages among charts in the second embodiment;

FIG. 6 is a diagram illustrating an example of a directed graph representing a relation of operation linkages among charts in the second embodiment;

FIG. 7 is a diagram illustrating an example of a UI for setting operation linkages of charts in the second embodiment;

FIG. 8A is a diagram illustrating an example (ordered linkage) of operation linkages among pieces of display information in the second embodiment;

FIG. 8B is a diagram illustrating an example (branched linkage) of operation linkages among the pieces of display information in the second embodiment;

FIG. 8C is a diagram illustrating an example (looped linkage) of operation linkages among the pieces of display information in the second embodiment;

FIG. 9 is a diagram illustrating an example of information propagation by operation linkages between charts among pieces of display information in the second embodiment; and

FIG. 10 is a diagram illustrating an example of a hardware configuration of a computer used in the information processing system according to the first and second embodiments.

### DETAILED DESCRIPTION

According to an embodiment, a computer program product has a computer readable medium including programmed instructions. The instructions, when executed by a computer, cause the computer to function as a first rendering unit, an input control unit, a first processing unit, a second processing unit, and a second rendering unit. The first rendering unit is configured to render a first chart from first visualization object data. The input control unit is configured to receive an operation input to the first chart. The first processing unit is configured to update the first visualization object data based on the operation input. The second processing unit is configured to, when second visualization object data is updated in a manner linked to processing performed by the first processing unit, update the second visualization object data. The second rendering unit is configured to render a second chart from the second visualization object data.

In a conventional visualization system, on the assumption that a common key or a common column is contained in a plurality of pieces of visualization object data, charts are operated in a linked manner. The charts are associated with each other by the common key or the common column of the pieces of data. When one piece of visualization object data is selected by operating a chart, another piece of visualization object data or a chart corresponding to the other piece of visualization object data is linked. For example, when a table A and a table B have a common ID column and data in the table A is selected, related data in the table B can be selected to be updated with this common ID column. Thus, a chart corresponding to the table A and a chart corresponding to the table B can be operated in a manner linked to each other.

However, there is a situation in which a common key or a common column among a plurality of data sets corresponding to a plurality of charts cannot be obtained. For example, in visual analysis of large-scale data or high-dimensional data, when all pieces of the data cannot be stored in a memory, a specific common key or common column is not contained in a plurality of data sets corresponding to the respective charts. In this case, in a screen formed by a plurality of charts, among screens of local machines, and among remote screens distributed in a plurality of machines, operation linkages among charts may not be flexibly combined, and thus feasibility and usability of a data analysis function are lacking.

Hereinafter, with reference to the attached drawings, embodiments of a computer program and an information processing method will be described in detail, which enable operation linkages among charts rendered from pieces of visualization object data by causing updating to be linked to each other between the pieces of visualization object data.

### First Embodiment

An information processing system according to a first embodiment will be described first.

Example of Functional Configuration

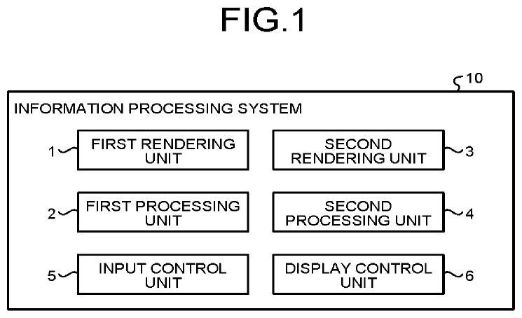

FIG. 1 is a diagram illustrating an example of a functional configuration of this information processing system 10 according to the first embodiment. The information processing system 10 according to the first embodiment includes a first rendering unit 1, a first processing unit 2, a second rendering unit 5, a second processing unit 4, an input control unit 5, and display control unit 6.

The first rendering unit 1 renders a first chart from first visualization object data. The first visualization object data is data to be visualized (e.g., table data). The first chart is data obtained so that the first visualization object data can be visually identified (e.g., a diagram, a table, or a graph). The first rendering unit 1 is made by a rendering process, for example.

The first processing unit 2 updates the first visualization object data on the basis of an operation input to the first chart. The first processing unit 2 is made by a processing process called a container, for example. The container is a process of implementing processing logic including extract, transform, and load (ETL) and machine learning, for example.

The second rendering unit 3 renders a second chart from second visualization object data. The second visualization object data is data to be visualized (e.g., table data, tree-structure data). The second chart is data obtained so that the second visualization object data can be visually identified (e.g., a diagram, a table, or a graph). When the second visualization object data has been updated, the second rendering unit 3 renders the second chart again. The second rendering unit 3 is made by a rendering process, for example.

When the second visualization object data is updated in a manner linked to processing performed by the first processing unit 2, the second processing unit 4 updates the second visualization object data. The second processing unit 4 is made by a processing process called a container, for example.

The input control unit 5 receives the operation input to the first chart.

The display control unit 6 controls display of display information. For example, the display control unit 6 controls display of a plurality of pieces of display information including at least one of the first chart (a chart from which a linkage is formed), and the second chart (a chart to which a linkage is formed) described above.

Herein, the information processing system 10 according to the first embodiment may be built by one computer (information processing device) or may be built by a plurality of computers.

In the example of FIG. 1 described above, a case in which two rendering units and two processing units (containers) are included is exemplified. However, the number of rendering units and the number of processing units may be optionally determined. For example, one processing unit may correspond to one rendering unit, a plurality of processing units may correspond to one rendering unit, or one processing unit may correspond to a plurality of rendering units. Alternatively, a pair of a rendering unit and a processing unit may be built by one computer, and a plurality of the computers may be combined to build the information processing system 10.

Example of Visualization Method

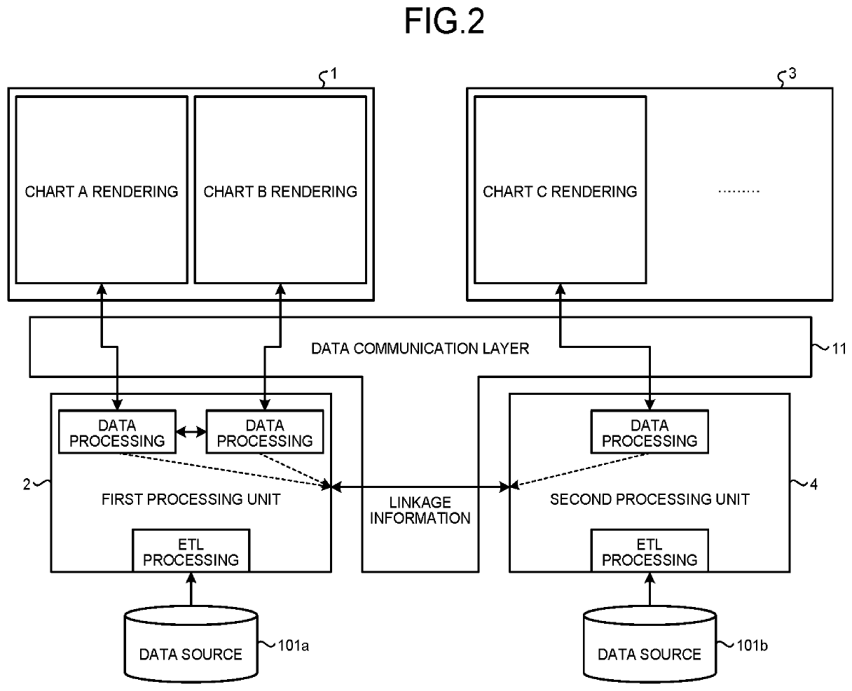

FIG. 2 is a diagram illustrating an example of a visualization method according to the first embodiment. The first rendering unit 1 performs a process of rendering charts A and B as the above-described first chart. The charts A and B are contained in one piece of display information (one screen), for example.

The second rendering unit 3 performs a process of rendering a chart C as the above-described second chart. The chart C is contained in one piece of display information (one screen) that is different from the piece of display information (one screen) of the charts A and B. Herein, the second rendering unit 3 may perform a process of rendering, as the second chart, a plurality of charts in addition to the chart C.

The first processing unit 2 performs ETL (Extract/Transform/Load) processing thereby acquiring, from a data source 101a, data to be supplied to the first rendering unit 1. The form of the data source 101a may be structured data or may be unstructured data.

Examples of the structured data include business applications and relational databases (RDBs) used in core systems and the like.

Examples of the unstructured data include documents, E-mails, web contents, audios, videos, and, computer-aided design (CAD) contents.

The first processing unit 2 performs a process of converting data acquired from the data source 101a into data that is appropriate to render the chart A, thereby generating visualization object data to be used for rendering the chart A. The visualization object data is identified by a processing unit name (container name) and a visualization object data name (data ID), for example.

In the same manner, the first processing unit performs a process of converting data acquired from the data source 101a into data that is appropriate to render the chart B, thereby generating visualization object data to be used for rendering the chart B.

The first processing unit 2 supplies, via a data communication layer 11, the visualization object data to be used for rendering the chart A and the visualization object data to be used for rendering the chart B to the first rendering unit 1.

The first processing unit 2 also supplies, via the data communication layer 11, linkage information including a selecting range of data to the second processing unit 4.

The second processing unit 4 performs ETL processing thereby acquiring, from a data source 101b, data to be supplied to the second rendering unit 3. The form of the data source 101 may be structured data or may be unstructured data.

The second processing unit 4 performs a process of converting data acquired from the data source 101b into data that is appropriate to render the chart C, thereby generating visualization object data to be used for rendering the chart C.

The second processing unit 4 supplies, via the data communication layer 11, the visualization object data to be used for rendering the chart to the second rendering unit 3.

The above-described first processing unit 2 generates visualization object data to be supplied to the first rendering unit 1. Specifically, the first processing unit 2 extracts partial data that is minimally required to generate a chart for the first rendering unit and convert the data into an appropriate form. The above-described second processing unit 4 also operates in the same manner as the first processing unit 2 does.

The correspondence relation between data processing (a module or a process) and a chart does not have to be a one-to-one relation. One piece of visualization object data may be provided to a plurality of charts so as to correspond thereto. Alternatively, a plurality of pieces of visualization object data may be combined and provided to one chart so as to correspond thereto.

Furthermore, the combination of the first processing unit 2 (second processing unit 4) and the first rendering unit 1 (second rendering unit 2) does not have to be limited to one-to-one combination. For example, visualization object data processed by a plurality of processing units may be provided to a rendering unit corresponding to a screen. Alternatively, for example, the first rendering unit 1 may render the chart A from the visualization object data processed by the first processing unit 2 and may also render the chart B from the visualization object data processed by the second processing unit 4.

Example of Data Transmitting/Receiving Method

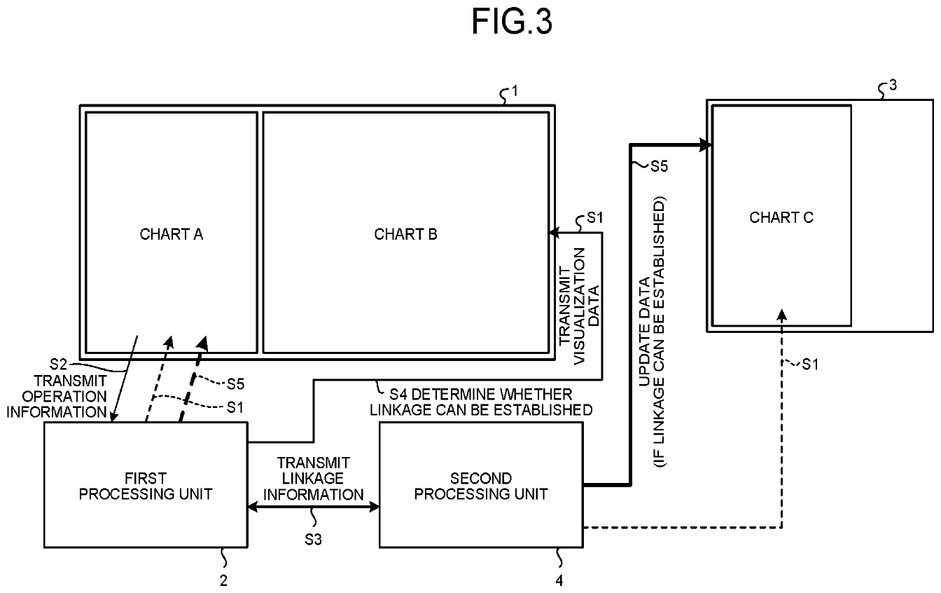

FIG. 3 is a diagram illustrating an example of a data transmitting/receiving method according to the first embodiment. To begin with, the first processing unit 2 transmits visualization object data to be used for rendering the chart A and visualization object data to be used for rendering the chart B to the first rendering unit 1, and the second processing unit 4 transmits visualization object data to be used for rendering the chart C to the second rendering unit 3 (step S1).

Subsequently, the first rendering unit 1 transmits operation information indicating an operation input to the chart A to the first processing unit 2 (step S2). The operation information is status information (or update information) of the chart A, for example. The status information includes a selection criterion such as a range of data specified by operating the chart A, for example, and is to be visualized.

Subsequently, the first processing unit compares the status information of the chart A including a selection criterion with pieces of visualization object data that the first processing unit 2 can access to determine a piece of visualization object data that is to be updated and transmits the piece of visualization object data to the first rendering unit 1. Thus, the chart A is updated.

The first processing unit 2 also notifies the second processing unit 4 about the above-described operation information (step S3).

Subsequently, triggered by this notification about the operation information, the second processing unit 4 determines, by either one or both of processing algorithms of the first processing unit 2 and the second processing unit 4, whether pieces of visualization object data that can be accessed by the second processing unit 4 can be updated (/linked) (step S4). Each processing algorithm has a function of determining whether such a linkage can be established based on detailed calculation or inference even without information on a common key or a common column. For example, whether to update a piece of visualization object data to be used for rendering the chart C is determined, based on the above-described operation performed on the chart A, by a knowledge matching algorithm and a machine learning algorithm, for example.

Subsequently, if the linkage can be established, the second processing unit 4 determines the piece of visualization object data that is to be updated in a linked manner and transmits this piece of visualization object data as updating data to the second rendering unit 3 (step S5). By processing at step S5, the chart C is updated.

When the chart A is linked by operating the chart C, processing is performed in reverse order to the above-described flow. Herein, even when the same processing unit performs these rendering processes, operation linkages among charts can be established in the same procedure as in the above-described flow. For example, the chart B can be linked by operating the chart A with the second processing unit 4.

As described above, in the information processing system 10 according to the first embodiment, the first rendering unit 1 renders the first chart from the first visualization object data. The input control unit 5 receives an operation input to the first chart. The first processing unit 2 updates the first visualization object data on the basis of the operation input. When the second visualization object data is updated in a manner linked to processing performed by the first processing unit 2, the second processing unit 4 updates the second visualization object data. The second rendering unit 3 renders/updates the second chart from the second visualization object data.

Consequently, with the information processing system 10 according to the first embodiment, operation linkages among charts rendered from pieces of visualization object data can be established by updating the pieces of visualization object data in a manner linked to each other.

### Second Embodiment

The following describes a second embodiment. In the description in the second embodiment, description that is the same as in the first embodiment is omitted.

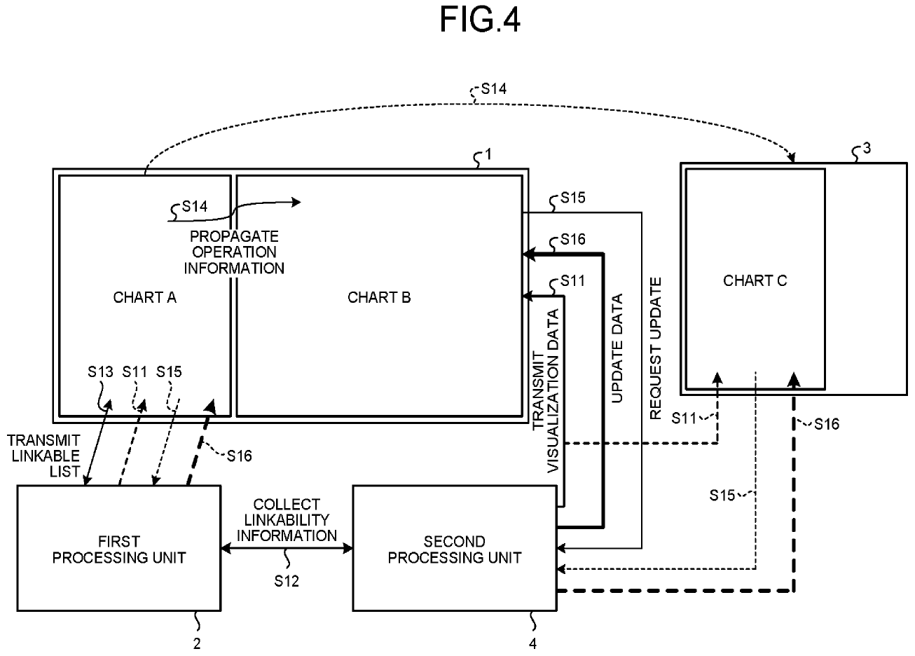

FIG. 4 is a diagram illustrating an example of a data transmitting/receiving method according to the second embodiment. To begin with, the first processing unit 2 transmits visualization object data to be used for rendering the chart A to the first rendering unit 1, and the second processing unit 4 transmits visualization object data to be used for rendering the chart B and visualization object data to be used for rendering the chart C to the first rendering unit 1 and the second rendering unit 3, respectively (step S11).

Subsequently, the first processing unit 2 collects, from each processing unit (the second processing unit 4 in the example of FIG. 4), linkability information indicating whether visualization object data to be processed in the processing unit can be linked (step S12).

Subsequently, the first processing unit transmits, to the first rendering unit 1, a linkable list indicating a candidate list of visualization object data that can be linked (step S13). In the example of FIG. 4, the first rendering unit 1 renders the charts A and B. The first rendering unit 1 may include one or multiple rendering modules. For example, the first rendering unit 1 may include one rendering module (or a process) to render chart A and chart B, or may include a rendering module that renders the chart A and a rendering module that renders the chart B.

Subsequently, the first rendering unit 1 propagates, to the charts B and C, status information of the chart A including a selection criterion such as a data selecting range updated by an operation input to the chart A (step S14). The method of propagation to the chart B uses intra-process communication or local inter-process communication because the propagation is performed within the same first rendering unit 1, and the method of propagation to the chart C uses inter-process communication from the first rendering unit 1 to the second rendering unit 3.

Subsequently, the first rendering unit 1 transmits a request to update the chart A to the first processing unit 2 and a request to update the chart B to second processing unit 4, and the second rendering unit 3 transmits a request to update the chart C to the second processing unit 4 S15). These update requests include selection criteria for data selection ranges, for example.

Subsequently, the first processing unit 2 calculates a piece of update data based on the update request transmitted by the processing at step S15 to transmit the piece of update data to the first rendering unit 1, and the second processing unit 4 calculates pieces of update data based on the update request transmitted by the processing at step S15 to transmit the respective pieces of update data to the first rendering unit 1 and the second rendering unit 3 (step S16). Specifically, for example, the second processing unit 4 (a module or a process) compares the received status information of the chart A including the selection criterion and piece of visualization object data that the second processing unit 4 can access. The second processing unit 4 then determines whether the pieces of visualization object data can be updated or calculates pieces of visualization object data that need to be updated and transmits the respective pieces of updated visualization object data to the first rendering unit 1 and the second rendering unit 3.

When the chart A is linked by operating the chart B or operating the chart C, processing is performed in reverse order to the above-described flow.

The first processing unit 2 and the second processing unit 4 described above are suitable for processing a large amount of data in a distributed manner. Each processing unit (called container) can perform a process of determining whether visualization object data can be linked and also a wide variety of processes ranging from a simple knowledge-based information matching algorithm to a deep learning algorithm in order to perform, for example, calculation processing of update data that is calculated when the data can be linked.

The processing units or containers are independent of each other, and thus developments, distributions, and updates of the processing units are not influenced by each other.

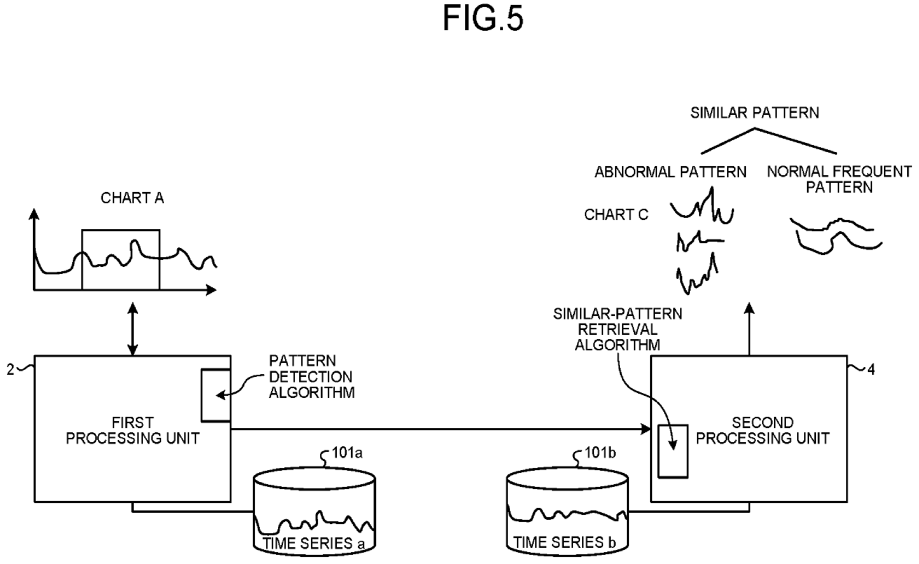

FIG. 5 is a diagram illustrating an example of operation linkages among charts in the second embodiment. The first processing unit 2 transmits visualization object data based on a data source 101a indicating a time series a, for example, to the first rendering unit 1. The first rendering unit 1 then renders the chart A.

The second processing unit 4 transmits visualization object data based on a data source 101b indicating a time series b, for example, to the second rendering unit 3. The second rendering unit 3 then renders the chart C.

Status information of the chart A including a selected range of a data specified by operating the chart A is transmitted to the first processing unit 2. A pattern detection algorithm of the first processing unit 2 detects abnormal patterns or normal frequent patterns of the time series a from a selected range of the data source 101a based on the status information of the chart A including the selected range.

The first processing unit 2 further transmits the normal frequent patterns or the abnormal patterns thus detected to the second processing unit 4. A similar-pattern retrieval algorithm of the second processing unit 4 retrieves, from the data source 101b, similar patterns that is similar to the abnormal patterns or the normal frequent patterns detected by the first processing unit 2. The second processing unit transmits visualization object data indicating this similar patterns to the second rendering unit 3. The second rendering unit 3 then updates the chart C.

As described above, even when pieces of visualization object data that are handled by the respective processing units are different, operation linkages among charts can be established by linking the pieces of visualization object data to each other by respective algorithms such as a knowledge matching algorithm and a machine learning algorithm.

By the information processing system 10 according to the second embodiment, operation linkability among charts can be abstracted into a directed graph indicating operation linkages among a plurality of charts can be made.

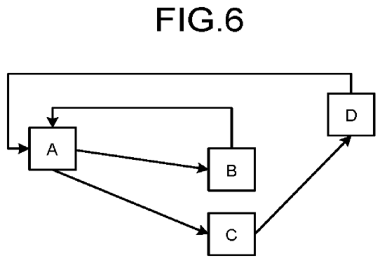

FIG. 6 is a diagram illustrating an example of a directed graph representing an abstract relation of the operation linkages among the charts in the second embodiment. However, in actual implementation of such a directed graph indicating operation linkages among charts, it may be difficult to grasp the whole relationship of the linkages, and also an infinite loop of operation linkages may occur. For example, if a directed graph indicates linkages from chart A to chart B and from chart B to chart A, an operation on chart. A may trigger an event from chart A to chart B to update chart B; the updating chart B will trigger another event and send it back to chart A. In order to block dead loop of such event propagations, the display control unit 6 displays a candidate list of linkable charts (or visualization object data) on each chart to control the operation linkages such that a user's intention is reflected therein. The detail of blocking dead loop is described in the follows.

Settings of Linkages among Charts

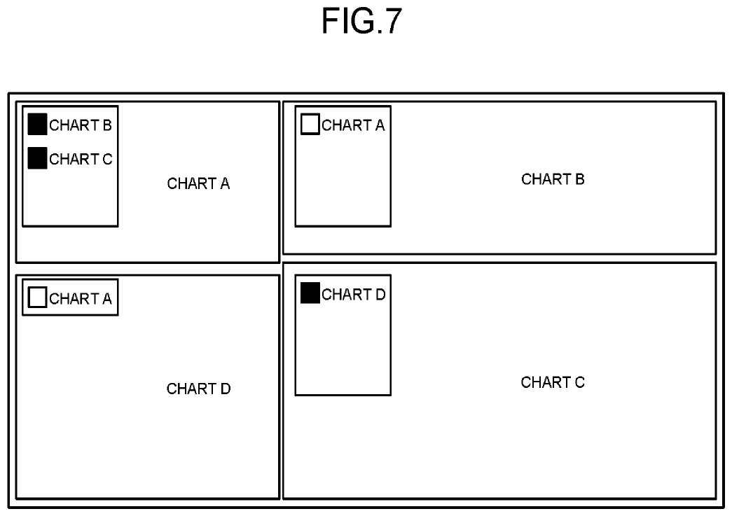

FIG. 7 is a diagram illustrating an example of a user interface (UI) for setting operation linkages of charts in the second embodiment. In the example of FIG. 7, popup lists of linkable charts is displayed for each chart. The input control unit 5 receives, in each of charts A to B (or pieces of visualization object data corresponding to the charts A to D), an popup list indicating which charts will be linked (or a piece of visualization object data corresponding to the chart) from each chart. For example, in the chart A, linkages to the charts B and C are set to be established. By this setting, the status information (operation information) of the chart A is conveyed to the charts B and C when the chart A is operated (see FIG. 4).

For example, the pop up menu in chart C indicates that a linkage to the chart D can be established. In the chart B or chart D, the linkage to the linkable chart A is set not to be established. With the UI (User Interface) as illustrated in FIG. 7, linkages among charts (pieces of visualization object data) can be controlled by user on base of linkable lists.

The linkable list of each chart is provided by its corresponding processing unit 3 or processing unit 4 and transmitted to its corresponding rendering unit 1 or rendering unit 2 shown in FIG. 1. The linkable lists can be collected in processing units by changing metadata among processing units or/and by combining predefined rules or knowledge to linking visualization object data in processing units.

By settings that indicate linkability among charts (e.g., flag settings), any directed graph can be made theoretically. In the information processing system 10 according to the second embodiment, in order to block an infinite loop of operation linkages, each operation information is propagated only from the operated chart to its linked chart(s) along the directed graph. Moreover, the display control unit 6 displays, as a candidate, visualization object data (chart) that can be directly linked to visualization object data (chart), and does not display, as a candidate, visualization object data hart) that can be indirectly linked to visualization object data a chart) via other visualization object data (or a chart).

Specifically, in the information processing system 10 according to the second embodiment, for example, even when operation linkages are established by the settings of linkages among charts in the order of the chart A to the chart B and the chart B to the chart A, the operation information of the chart A including a selecting range specified by operating the chart A is not automatically cycled back and forth between the chart A and the chart B. Similarly, the operation information of the chart B is not automatically cycled back and forth between the two charts.

Settings of Linkages Among Pieces of Display Information (Screens)

Operation linkages among charts among pieces of display information (screens) are a little more complicated. To begin with, linkability among pieces of display information (screens) is set, and then linkability among charts is set among pieces of display information that can be linked.

The order of linkages among pieces of display information is classified into an ordered linkage, a branched linkage, and a looped linkage.

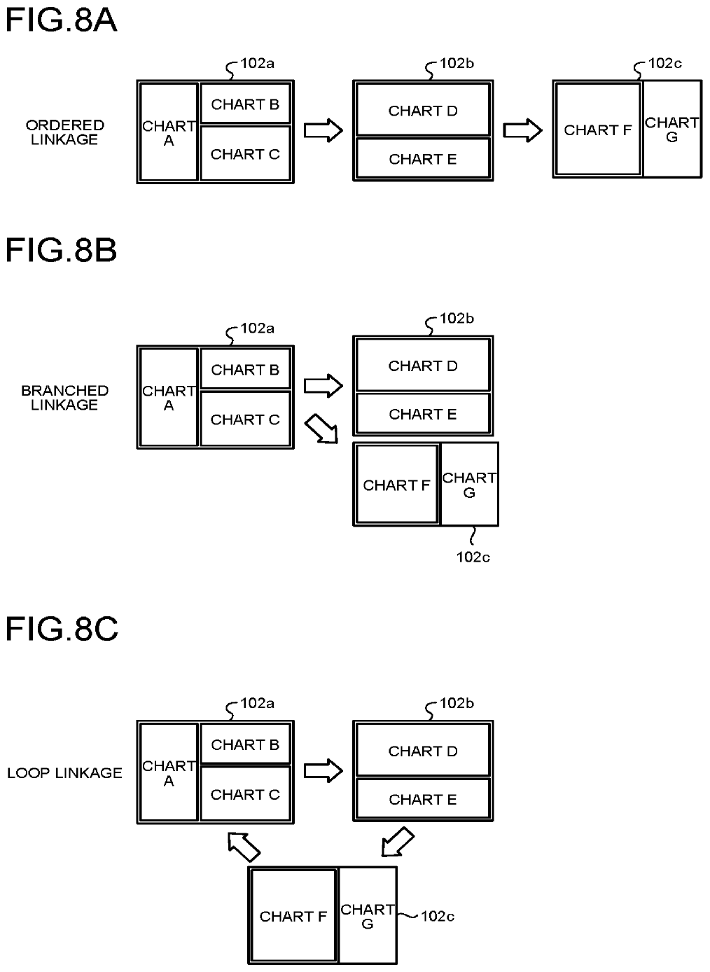

FIG. 8A is a diagram illustrating of an example (ordered linkage) of operation linkages among pieces of display information 102a to 102c in the second embodiment. FIG. 8B is a diagram illustrating of an example (branched linkage) of operation linkages among the pieces of display information 102a to 102c in the second embodiment. FIG. 8C is a diagram illustrating an example (looped linkage) of operation linkages among the pieces of display information 102a to 102c in the second embodiment. The display information 102a includes charts A, B, and C. The display information 102b includes charts D and E. The display information 102c includes charts F and G.

Hereinafter, these pieces of display information 102a to 102c are simply called “pieces of display information 102” unless they are distinguished.

Theoretically, by linkage settings among the pieces of display information 102 (e.g., flag settings), any directed graph indicating linkages among the pieces of display information 102 can be made. As in the settings of linkages among charts described above, also operation linkages among the pieces of display information 102 can be controlled by the linkage settings among the pieces of display information 102 such that a user's intention is reflected therein.

In order to block an infinite loop of operation linkages, each operation linkage between the pieces of display information 102 is propagated only from the operated piece of display information to the corresponding pieces of display information 102 along the directed graph. Moreover, the display control unit 6 displays, as a candidate list, pieces of display information 102 that can be directly linked, and does not display, pieces of display information 102 that can be indirectly linked via another piece of display information 102.

Specifically, in the information processing system 10 according to the second embodiment, for example, as shown in FIG. 8A, even when operation linkages are established by the settings of linkages among the pieces of display information 102 in the order of the display information 102a to the display information 102b and then the display information 102b to the display information 102c, the status information of a chart including a operation event specified by operating the chart included in the display information 102a is not automatically conveyed to the display information 102c via the display information 102b. Thus, in order to convey operation information from the display information 102a to the display information 102c, a flag of the operation linkage to the display information 102c needs to be set when the user interface of a list (candidates) of operation linkages of the display information 102a is show.

When the pieces of display information 102 are included in the same local machine, means for communicating with each other can be easily obtained. However, when the pieces of display information 102 are distributed in different remote machines, an information transmission path for transmitting information between the pieces of display information 102 is required. In the second embodiment, this information transmission path may be routed through processing units each configured to process visualization object data that is used for rendering a chart included in the pieces of display information 102.

For example, when the chart A included in the pieces of display information 102 to be rendered by the first rendering unit 1 in FIG. 4 described above and the chart C included in the pieces of display information 102 to be rendered by the second rendering unit 3 therein are linked to each other, information may be transmitted via the first processing unit and the second processing unit 4.

Similar to the linkage settings among charts inside a piece of display information, for example, the linkage settings among the pieces of display information 102 can be set, for each piece of display information, for example, by settings (e.g., flag settings) of selecting a piece of display information to be linked from a list of pieces of display information that is linkable.

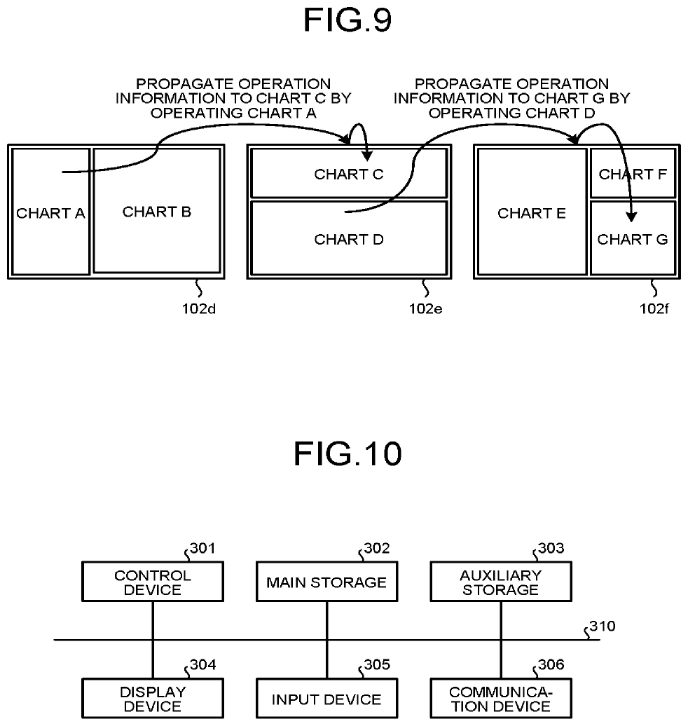

FIG. 9 is a diagram illustrating an example of information propagation by operation linkages between charts among the pieces of display information 102 in the second embodiment. In the example of FIG. 9, operation information (e.g., a selecting range of a data) for the chart A in the display information 102d is propagated to the chart C in the display information 102e. Operation information for the chart U in the display information 102e is propagated to the chart C in the display information 102f.

Specifically, in order to perform the control illustrated in FIG. 9, the display control unit 6 displays candidates of the pieces of display information 102 that is linkable to the display information 102d including the chart A (first chart) first. Subsequently, the input control unit 5 receives an operation input of selecting the display information 102e as second display information to be linked to the display information 102d from the candidates of the pieces of display information 102. Subsequently, the input control unit 5 receives an operation input indicating settings of an operation linkage from the chart A (first chart) to the chart C (second chart) with the above-described UI in FIG. 7, for example. Subsequently, the second processing unit 4 updates visualization object data corresponding to the chart C in a manner linked to processing performed by the first processing unit 2. Subsequently, the second rendering unit 3 renders the chart C again. Propagation of operation information from the chart D the chart G is performed similarly.

As described in the foregoing, with the information processing system 10 according to the second embodiment, operation linkages among charts can be controlled (customized) with the UI in FIG. 7, for example. Similarly, also operation linkages among the pieces of display information 102 can be controlled (customized), for each piece of display information 102, by setting the pieces of display information 102 to be linked, as illustrated in FIG. 8A to 8C and FIG. 9 described above.

The following describes an example of a hardware configuration of a computer used in the information processing system 10 according to the first and second embodiments.

Example of Hardware Configuration

FIG. 10 is a diagram illustrating the example of a hardware configuration of a computer used in the information processing system 10 according to the first and second embodiments.

The computer used in the information processing system 10 includes a control device 301, a main storage 302, an auxiliary storage 303, a display device 304, an input device 305, and a communication device 306. The control device 301, the main storage 302, the auxiliary storage 303, the display device 304, the input device 305, and the communication device 306 are connected via a bus 310.

The control device 301 executes a computer program read from the auxiliary storage 303 into the main storage 302. The main storage 302 is a memory such as a read only memory (ROM) or a random access memory (RAM). The auxiliary storage 303 is a hard disk drive (HDD) or a memory card, for example.

The display device 304 displays the pieces of display information 102. The display device 304 is a liquid crystal display, for example. The input device 305 is an interface for operating the computer. The input device 305 is a keyboard or a mouse, for example. When the computer is a smart device such as a smartphone or a tablet-type terminal, a touch panel thereof, for example, serves as the display device 304 and the input device 305. An input device such as a microphone or a camera is also conceivable while incorporating a voice recognition module or an image recognition module into a processing unit. The communication device 306 is an interface for communicating with other devices.

The computer program to be executed by the computer is provided as a computer program product that is stored, as a file in an installable format or an executable format, in a computer-readable recording medium such as a CD-ROM, a memory card, a CD-R, or a digital versatile disc (DVD).

The computer program to be executed by the computer may be configured to be stored in a computer connected to a network such as the Internet and be downloaded via the network to be provided. Alternatively, the computer program to be executed by the computer may be configured to be provided via a network such as the Internet without being downloaded.

Alternatively, the computer program to be executed by the computer may be configured to be provided in a manner installed in a ROM or the like in advance.

The computer program to be executed by the computer is configured as a module including, out of functional blocks in FIG. 1 described above, functional blocks that can also be implemented by the computer program. As an actual hardware, the control device 301 reads the computer program from the recording medium to execute the computer program, whereby the respective functional blocks are loaded into the main storage 302. In other words, the respective functional blocks are generated on the main storage 302.

For example, the computer program to be executed by the computer is a computer program for causing the computer to function as: the first rendering unit 1 that renders a first chart from first visualization object data; the input control unit 5 that receives an operation input to the first chart; the first processing unit 2 that updates the first visualization object data, based on the operation input; the second processing unit 4 that, when second visualization object data is updated in a manner linked to processing performed by the first processing unit 2, updates the second visualization object data; and the second rendering unit that renders a second chart from the second visualization object data.

Alternatively, for example, the computer program to be executed by the computer is a computer program for causing the computer to function as: the first rendering unit 1 that renders a first chart from first visualization object data; the input control unit 5 that receives an operation input to the first chart; and the first processing unit 2 that updates the first visualization object data, based on the operation input. When second visualization object data is updated in a manner linked to processing performed by the first processing unit 2, the first processing unit 2 notifies the second processing unit 4 that updates the second visualization object data about information updated by the processing performed by the first processing unit 2.

Alternatively, for example, the computer program to be executed by the computer is a computer program that causes the computer to function as the second processing unit 4 and the second rendering unit 3. When the second processing unit 4 receives, from the first processing unit that updates first visualization object data based on an operation input to a first chart rendered from the first visualization object data, information updated by processing performed by the first processing unit 2, the second processing unit 4 updates second visualization object data in a manner linked to the processing performed by the first processing unit 2. The second rendering unit 3 renders a second chart from the second visualization object data.

Some or all of the respective functional blocks described above may be implemented by hardware such as an integrated circuit (IC) without being Implemented by software.

When the respective functions are implemented with a plurality of processors, each processor may implement one of the respective functions or may implement two or more of the respective functions.

The operating form of the computer that builds the information processing system 10 according to the first and second embodiments may be optionally determined. The information processing system 10 according to the first and second embodiments may be operated as a cloud system on a network, for example.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A computer program product having a non-transitory computer readable medium including programmed instructions, wherein the instructions, when executed by a computer, cause the computer to function as:
a first rendering unit configured to render a first chart from first visualization object data;
an input control unit configured to receive an operation input to the first chart;
a first processing unit configured to update the first visualization object data based on the operation input;
a second processing unit configured to, when second visualization object data is updated in a manner linked to processing performed by the first processing unit, update the second visualization object data; and
a second rendering unit configured to render a second chart from the second visualization object

2. The product according to claim 1, wherein
the instructions, when executed by a computer, further causes the computer to function as a display control unit configured to display a first candidate indicating a candidate of the second visualization object data that is linkable to the first visualization object data,
the input control unit receives an operation input of selecting, from the first candidate, one or more pieces of the second visualization object data to be linked to the first visualization object data, and
the second processing unit updates the one or more pieces of the second visualization object data selected from the first candidate, in a manner linked to processing performed by the first processing unit.

3. The product according to claim 2, wherein
the display control unit controls display of a plurality of pieces of display information including at least one of the first chart and the second chart, and displays a second candidate indicating a candidate of second display information that is linkable to first display information including the first chart,
the input control unit receives an operation input of selecting, from the second candidate, one or more pieces of second display information to be linked to the first display information including the first chart, and
the second processing unit updates, in a manner linked to processing performed by the first processing unit, a piece of the second visualization object data that is selected from the first candidate, and corresponds to a second chart included in a piece of the second display information selected from the second candidate.

4. The product according to claim 2, wherein
the display control unit displays user interface of, as the first candidates, pieces of the second visualization object data that are directly linkable to the first visualization object data and does not display, as the candidates, pieces of the second visualization object data that is indirectly linkable to the first visualization object data with presence of other linkable visualization object data between the first visualization object data and the second visualization object data,
the linked second visualization object data are selected from the linkable first candidates by user with the above user interface, and
the operation input is propagated froze an operated chart corresponding to the first visualization object to charts corresponding to the linked second visualization object data.

5. The product according to claim 3, wherein
the display control unit displays user interface of, as the second candidates, pieces of the second display information that are directly linkable to the first display information and does not display, as the second candidates, pieces of the second display information that is indirectly linkable to the first display information with presence of other linkable pieces of display information between the first piece of display information and the second pieces of display information,
the linked pieces of the second display information are selected from the linkable pieces of the second display information by user with the above user interface, and
the operation input is propagated from an operated chart in the first piece of display information to charts in the linked pieces of the second display information.

6. A computer program product having a non-transitory computer readable medium including programmed instructions, wherein the instructions, when executed by a computer, cause the computer to function as:
a first rendering unit configured to render a first chart from first visualization object data;
an input control unit configured to receive an operation input to the first chart; and
a first processing unit configured to update the first visualization object data, based on the operation input, wherein
when second visualization object data is updated in manner linked to processing performed by the first processing unit, the first processing unit notifies a second processing unit about information updated by the processing performed by the first processing unit, the second processing unit being configured to update the second visualization object data.

7. A computer program product having a non-transitory computer readable medium including programmed instructions, wherein the instructions, when executed by a computer, cause the computer to function as a second processing unit and a second rendering unit, wherein
when the second processing unit receives, from a first processing unit that updates first visualization object data based on an operation input to a first chart rendered from the first visualization object data, information updated by processing performed by the first processing unit, the second processing unit updates second visualization object data in a manner linked to the processing performed by the first processing unit, and
the second rendering unit renders a second chart from the second visualization object data.

8. An information processing method comprising:
rendering a first chart from first visualization object data;
receiving an operation input to the first chart;
updating the first visualization object data, based on the operation input;
updating, when second visualization object data is updated in a manner linked to the updating, the second visualization object data; and
rendering a second chart from the second visualization object data.
